(19) United States
(12) Patent Application Publication
(10) Pub. No.: US 2022/0268902 A1
(43) Pub. Date: Aug. 25, 2022

(54) LIDAR SYSTEM AND METHOD FOR DETERMINING DISTANCES OF TARGETS

(71) Applicant: NATIONAL RESEARCH COUNCIL OF CANADA, Ottawa (CA)

(72) Inventor: Oliver James Pitts, Ottawa (CA)

(21) Appl. No.: 17/638,627

(22) PCT Filed: Aug. 17, 2020
(86) PCT No.: PCT/IB2020/057736

§ 371 Date: Feb. 25, 2022

Related U.S. Application Data
(60) Provisional application No. 62/893,280, filed on Aug. 29, 2019.

(51) Int. Cl. G01S 7/487; G01S 17/26; G01S 7/481; G01S 7/4865

(52) U.S. Cl. CPC G01S 7/4873; G01S 7/4876; G01S 17/26; G01S 7/4817; G01S 7/4865; G01S 17/89

(57) ABSTRACT

An example device to determine a distance of a target includes: an emitter to emit light pulses according to a device-identifying spatial pattern; a detector to detect light forming an incoming spatial pattern; and a processor interconnected with the emitter and the detector, the processor configured to: determine whether the incoming spatial pattern is valid based on the device-identifying spatial pattern; and when the incoming spatial pattern is valid, determine the distance of the target based on the incoming spatial pattern.

### FIELD

The specification relates generally to distance and ranging, and more particularly to a light detection and ranging (LIDAR) system and method for determining distances of targets.

### BACKGROUND

A LIDAR device is used to determine distances of targets based on a time-of-flight computation of reflected light from the device. Direct or reflected light beams from other nearby LIDAR devices may cause mutual interference and may result in serious errors in scene mappings with two LIDAR devices operated in proximity. Sequentially pulsed coding may be employed to uniquely identify each unit however a much higher pulse rate is used to achieve the same resolution for mapping. Accordingly, sequentially pulsed coding is constrained as to the pulse rate that can be achieved.

### SUMMARY

According to an aspect of the present specification, a device to determine a distance of a target includes an emitter to emit light pulses according to a device-identifying spatial pattern; a detector to detect light forming an incoming spatial pattern; and a processor interconnected with the emitter and the detector, the processor configured to: determine whether the incoming spatial pattern is valid based on the device-identifying spatial pattern; and when the incoming spatial pattern is valid, determine the distance of the target based on the incoming spatial pattern.

According to another aspect of the present specification, a method, in a distancing device, of determining a distance of a target is provided. The method includes: emitting light pulses according to a device-identifying spatial pattern; detecting light forming an incoming spatial pattern; determining whether the incoming spatial pattern is valid based on the device-identifying spatial pattern; and when the incoming spatial pattern is valid, determining the distance of the target based on the incoming spatial pattern.

### BRIEF DESCRIPTION OF DRAWINGS

Implementations are described with reference to the following figures, in which:

FIG. 1 depicts an example system for determining distances of targets;

FIG. 2 depicts a block diagram of an example device in the system of FIG. 1;

FIG. 3A depicts an example device-identifying spatial pattern of the device of FIG. 2;

FIG. 3B depicts an example incoming spatial pattern detected by the device of FIG. 2;

FIG. 4 depicts a flowchart of an example method for determining target distances in the system of FIG. 1;

FIG. 5 depicts an example system for determining distances of targets including multiple distancing devices;

FIG. 6A depicts an example broad area spatial pattern; and

FIG. 6B depicts two example incoming spatial patterns.

### DETAILED DESCRIPTION

Interference between LIDAR devices operated in proximity may result in serious errors in image mapping, due to direct or reflected light beams causing mutual interference. Sequentially pulsed coding may be employed to uniquely identify each unit however a much higher pulse rate is used to achieve the same resolution for mapping. Accordingly, sequentially pulsed coding is constrained as to the pulse rate that can be achieved.

A LIDAR device may emit spatially patterned light pulses. Specifically, the light pulses may be spatially patterned to uniquely identify each LIDAR device. That is, each LIDAR device may be imprinted with a unique device-identifying spatial pattern. Upon detection of an incoming spatial pattern of light, the LIDAR device may filter the incoming spatial pattern based on the device-identifying spatial pattern. In particular, direct or reflected light beams from other units are unlikely to coincide with the device-identifying spatial pattern, and hence can be filtered out as being invalid. The incoming spatial patterns which are determined to be valid (i.e. originating from the source unit itself) may be used to more accurately determine distances of targets.

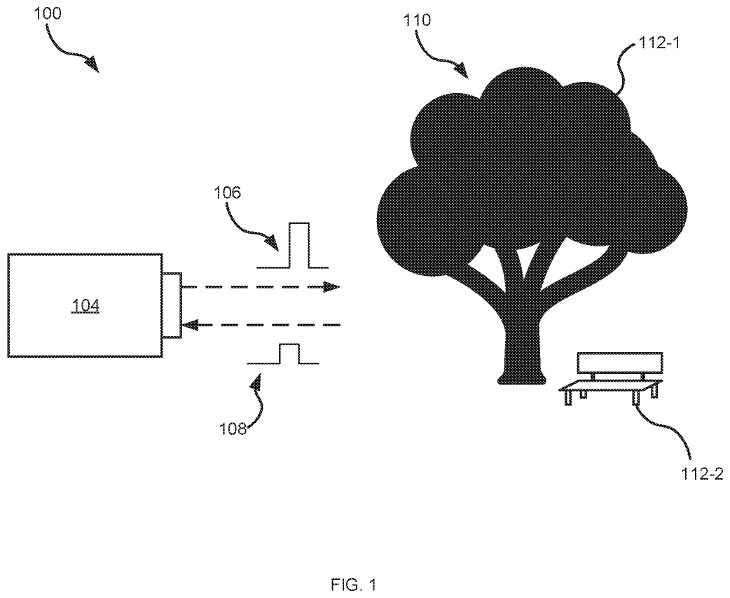

FIG. 1 depicts an example system 100 for determining distances of targets. The system 100 includes a distancing device 104 (also referred to herein as simply the device 104) for determining distances of targets. Specifically, the device 104 is oriented towards a scene 110 including a tree 112-1 and a bench 112-2 (referred to collectively as the targets 112 and generically as an target 112) and emits light pulses 106 towards the scene 110 to determine the distance of the one or more of the targets 112 of the scene. The light pulses 106 are reflected off of the targets 112 to form reflected pulses 108. The reflected pulses 108 are received by the device 104 and processed to determine the distance of the target 112 from which the reflected pulses 108 were reflected.

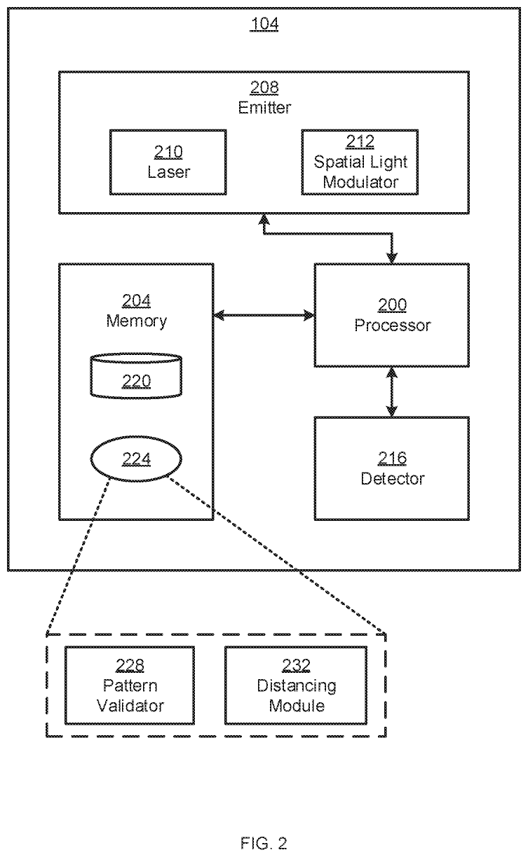

FIG. 2 depicts certain internal components of the device 104. The device 104 includes a processor 200, a memory 204, an emitter 208, and a detector 216.

The processor 200 may include a central-processing unit (CPU), a microcontroller, a microprocessor, a processing core, a field-programmable gate array (FPGA) or similar. The processor 200 may include multiple cooperating processors. The processor 200 may cooperate with the memory 204 to execute instructions to realize the functionality discussed herein. In particular, the processor 200 is configured to determine whether an incoming spatial pattern is valid and to perform the distancing operation when the incoming spatial pattern is valid. The memory 204 may be a combination of volatile (e.g. Random Access Memory or RAM) and non-volatile memory (e.g. read-only memory or ROM, Electrically Erasable Programmable Read Only Memory or EEPROM, flash memory). All or some of the memory 204 may be integrated with the processor 200. The processor 200 and the memory 204 may be comprised of one or more integrated circuits. The memory 204 stores a repository 220 containing, for example, device data, such as a device-identifying spatial pattern, pattern generation rules, target data, such as target identifiers and target distances, and the like.

The memory 204 also stores a plurality of applications, each including a plurality of computer-readable instructions executable by the processor 200. The applications stored in the memory 204 include a control application 224. As will be understood by those skilled in the art, the processor 200 executes the instructions of the control application 224 (and any other suitable applications) in order to perform various actions defined by the instructions contained therein. In the description below, the processor 200, and more generally the device 104 are said to be configured to perform those actions. It will be understood that they are so configured via execution (by the processor 200) of the instructions of the control application 224 stored in the memory 204. In particular, execution of the control application 224, as will be discussed in greater detail below, generally configures the processor 200 to determine whether an incoming spatial pattern is valid and to perform the distancing operation when the incoming spatial pattern is valid. Specifically, the control application 224 includes a pattern validator 228 and a distancing module 232. As will be appreciated, in some examples, the control application 224 may be implemented as a suite of distinct applications.

In some examples, the device 104 may further include a communications interface (not shown) interconnected with the processor 200. The communications interface includes suitable hardware (e.g. transmitters, receivers, network interface controllers and the like) allowing the device 104 to communicate with other computing devices. The specific components of the communications interface are selected based on the type of network or other links that the device 104 communicates over. The device 104 can be configured, for example, to communicate with a server via one or more links (e.g. wireless links including one or more wide-area networks such as the Internet, mobile networks, and the like, or wired links) to send and receive device data, target data, including target distances, and the like.

The device 104 further includes the emitter 208 interconnected with the processor 200. The processor 200 is configured to control the emitter 208 to emit light pulses in a direction towards the target 112 toward which the device 104 is oriented for a distancing operation. More particularly, the emitter 208 is configured to emit light pulses according to a device-identifying spatial pattern. The device-identifying spatial pattern may be, for example, a 2-dimensional barcode, and may encode device-identifying information. In other examples, the device-identifying spatial pattern may simply be another suitable spatial pattern (e.g. including curved features, shapes, and the like) which allows the device 104 to be uniquely identified. In particular, the device-identifying spatial pattern may be formed on a plane substantially perpendicular to a direction of emission of the light pulses. Accordingly, the device-identifying spatial pattern is substantially perpendicular to the direction of the measured distance to the target.

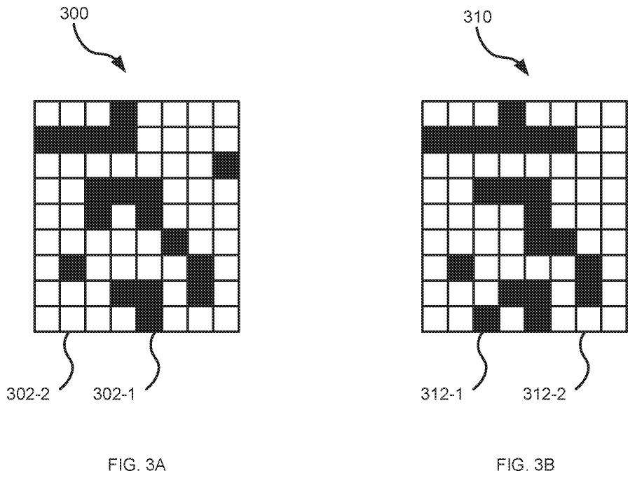

For example, referring to FIG. 3A, an example device-identifying spatial pattern 300 is depicted. The device-identifying spatial pattern 300 forms a rectangular array of pixels. The device-identifying spatial pattern 300 may be stored in the memory 204, and in particular, in the repository 220. The processor 200 may thus obtain the pattern 300 from the memory 204 and control the emitter 208 to emit the light pulses according to the pattern 300. For example, the pattern may include emitted light pixels 302-1 (i.e. pixels for which light is to be emitted by the emitter 208 to form the pattern 300), represented by the shaded squares, as well as dark pixels 302-2 (i.e. pixels for which light is not emitted), represented by the unshaded squares. In some examples, the pattern 300 may alternate, for example to reduce wear on the pattern-producing components of the emitter 208. That is, during some distancing operations, the light pixels 302-1 may be produced at the shaded squares, while in other distancing operations, the light pixels 302-1 may be produced at the unshaded squares.

In further examples, the device-identifying spatial pattern may be randomly or pseudo-randomly generated or may otherwise vary between distancing operations. For example, the processor 200 may generate the device-identifying spatial pattern based on pattern generation rules stored in the memory 204. In some examples, the device 104 may include an input device to allow an operator to select or generate a device-identifying spatial pattern. In other examples, the device 104 may cooperate with a server or other external computing device to obtain a device-identifying spatial pattern at each instance of a distancing operation.

Referring again to FIG. 2, in the present example, the emitter 208 includes a laser 210 and a spatial light modulator 212. The laser 210 is configured to emit laser pulses in the range of about 600 nm to about 1000 nm (e.g. near-infrared laser pulses). The spatial light modulator 212 receives the laser pulses from the laser 210 and modulates the laser pulses to generate the spatial pattern. The spatial light modulator 212 may be any suitable system capable of generating the spatial pattern, such as a digital micromirror device (DMD), or the like. In other implementations, other suitable emitters configured to generate the spatial pattern are contemplated. For example, the emitter 208 may include an array of lasers which are positioned or selectively actuated according to the spatial pattern.

The device 104 further includes the detector 216 interconnected with the processor 200. The detector 216 is a photodetector (e.g. a photoelectric cell or the like) configured to detect light. In particular, the detector 216 may be selected for sensitivity to the specific wavelength of light emitted by the emitter 208. The detector 216 is further configured to identify a spatial pattern of the detected light. That is, the detector 216 may comprise a plurality of photo-detecting cells to enable the detector 216 to generate an incoming spatial pattern at a sufficient resolution based on the detected light. More particularly, the detector 216 defines the incoming spatial pattern as a spatial pattern of light incident upon the detector 216 at a given instance in time. In some implementations, the detector 216 may have the same resolution as the spatial pattern emitted by the spatial light modulator 212, allowing the detected light pixel to be mapped to an emitted light pixel for distancing operations.

In some examples, the detector 216 may include an array of detector cells, wherein each detector cell detects light independently. In such examples, the detector 216 may define the incoming spatial pattern as a combination of the light incident upon each independent detector cell within a predetermined interval of time. That is, light detected by each detector cell within the predetermined interval of time forms a portion of the incoming spatial pattern detected by the detector 216.

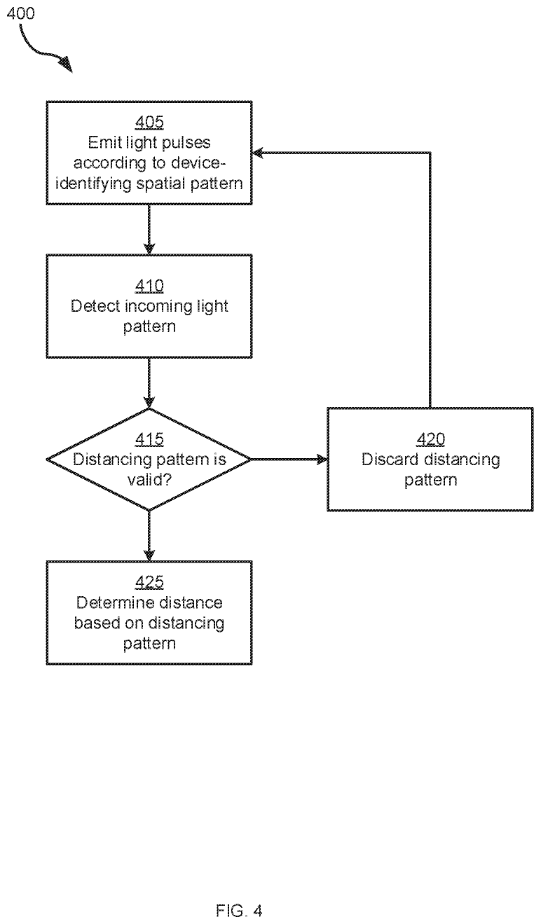

The functionality of the device 104, as implemented via execution of the control application 224 by the processor 200 will now be described in greater detail with reference to FIG. 4. FIG. 4 illustrates a method 400 of determining a distance of a target. The method 400 will be discussed in conjunction with its performance in the system 100, and in particular, with reference to the components illustrated in FIG. 2.

The method 400 is initiated at block 405, for example, in response to an initiation signal, such as an input from an operator of the device 104. For example, an operator may trigger a trigger button to initiate a distancing operation at the device 104. At block 405, the device 104, and in particular, the emitter 208, is configured to emit spatially patterned light pulses 106 towards the target 112, according to the device-identifying spatial pattern 300.

For example, the memory 204 may store the device-identifying spatial pattern 300, and accordingly, the processor 200 may obtain the device-identifying spatial pattern 300 from the memory and control the emitter 208 to emit the light pulses 106 according to the pattern 300. In other examples, the processor 200 may generate a random or pseudo-random device-identifying spatial pattern according to the pattern generation rules stored in the memory 204.

Upon obtaining the pattern 300, the processor 200 controls the emitter 208 to emit the spatially patterned light pulses towards the target 112. More particularly, the processor 200 may control the laser 210 to emit laser pulses. The processor 200 may further control the spatial light modulator 212 to modulate the laser pulses from the laser 210 according to the device-identifying spatial pattern 300 to generate the spatially patterned light pulses 106.

Returning to FIG. 4, the spatially patterned light pulses 106 are directed towards the target 112 and reflect off the target 112 to generate reflected pulses 108. At block 410, the device 104, and in particular, the detector 216 is configured to detect the reflected pulses 108. In particular, the detector 216 identifies an incoming spatial pattern from the detected reflected light pulses 108.

For example, referring to FIG. 3B, an incoming spatial pattern 310 is depicted. The incoming spatial pattern 310 includes detected light pixels 312-1, depicted by the shaded squares and representing pixels at which light is detected by the detector 216, and dark pixels 312-2, depicted by the unshaded squares and representing pixels at which light is not detected by the detector 216. In particular, the emitted light pulses 106 may be distorted by surface contours or other interference, and hence, the incoming spatial pattern 310 may be distorted relative to the emitted device-identifying spatial pattern 300. In other examples, the incoming spatial pattern 310 may include light detected from other nearby sources. Further, in systems where a plurality of distancing devices are utilized, the incoming spatial pattern 310 may include interfering light from the other distancing devices, such as reflected light pulses originating from a different device, or light emitted directly from a different device.

At block 415, the device 104, and in particular the pattern validator 228 determines whether the incoming spatial pattern 310 is valid based on the device-identifying spatial pattern 300. In particular, the pattern validator 228 determines a similarity score representing a similarity of the incoming spatial pattern and the device-identifying spatial pattern. When the similarity score exceeds a threshold similarity score, the pattern validator 228 may determine that the incoming spatial pattern is valid.

For example, the pattern validator 228 may be configured to determine the similarity score by determining a percentage of the incoming spatial pattern 310 which corresponds to the device-identifying spatial pattern 300. The threshold similarity score may thus be a threshold percentage. That is, the pattern validator 228 may determine a number or percentage of the emitted light pixels 302-1 which correspond to detected light pixels 312-1. If the number or percentage exceeds the threshold, the pattern validator 228 determines that the incoming spatial pattern 310 is valid. That is, the device 104 may determine that at least a threshold percentage of the device-identifying spatial pattern 300 was detected as being reflected back to the device 104, and hence the distance measurements obtained based on the detected light pulses 108 are more likely to be accurate.

In still further examples, the detector 216 and the emitter 208 may not have the same resolution. Accordingly, the pattern validator 228 may apply one or more image processing techniques to compute a similarity score between the emitted device-identifying spatial pattern 300 and the detected incoming spatial pattern 310. In particular, the similarity score may represent the similarity between the detected incoming spatial pattern 310 and the emitted device-identifying spatial pattern 300. If the computed similarity score exceeds a threshold similarity score, the incoming spatial pattern 310 may be determined to be valid.

In some examples, the pattern validator 228 may further validate the incoming spatial pattern 310 based on a time that the incoming spatial pattern 310 was detected at the detector 216. In particular, if the time between emission of the device-identifying spatial pattern 300 and detection of the incoming spatial pattern 310 exceeds a threshold time, the pattern validator 228 may determine that the detected incoming spatial pattern 310 is invalid. The threshold time may be based on a distancing range of the device 104, wherein targets outside the distancing range do not produce reliable reflected pulses.

If the incoming spatial pattern 310 is determined to be invalid at block 415, the method 400 proceeds to block 420. At block 420, the incoming spatial pattern 310 is discarded, and the method returns to block 405 to obtain new measurements.

If the incoming spatial pattern 310 is determined to be valid at block 415, the method 400 proceeds to block 425. At block 425, the device 104, and in particular the distancing module 232 is configured to determine the distance of the target based on the incoming spatial pattern 310. In particular, the distancing module 232 may obtain an emitted time at which the emitter 208 emitted the device-identifying spatial pattern and a detected time at which the detector 216 detected the incoming spatial pattern. The distancing module 232 may then compute a distance of the object based on the time of flight from the emitted light pixel 302-1 to the detected light pixel 312-1. The computed target distances may then be stored in the memory 204 for further processing. In some examples, where the detector 216 is composed of a plurality of detector cells, the distancing module 232 may compute a distance of the object with higher resolution based on the detected light at each of the detector cells, based on time-of-flight principles.

The device 104 may be configured to process the distances of the target to generate a depth/distance map of a scene (e.g. including the entirety of the scene 110). For example, the device 104 may be configured to perform a raster of the scene 110 to build up data including the target distances of the tree 112-1 and the bench 112-2. That is, the device 104 may illuminate a portion of the scene 110 with each pulse. The device 104 may then perform a scanning movement to a new position to determine a new distance of a new target. For example, the new target may be an adjacent portion of a target object. Accordingly, the device 104 may store the target distances computed at block 420 at each iteration of the method 400 during the composition of the rastered image.

In other examples, the device 104 may communicate the target distances to a server or other computing device, display the target distances at a display of the device 104, or the like.

Thus, as described above, a distancing device may include an emitter configured to emit light pulses according to a device-identifying spatial pattern towards an target for distancing, a detector configured to detect an incoming spatial pattern, and a processor to determine a validity of the incoming spatial pattern according to the device-identifying spatial pattern and determine the distance of the target based on valid incoming spatial patterns. Advantageously, by validating the incoming spatial pattern based on the device-identifying spatial pattern, the distancing device may obtain more accurate distance measurements by filtering the detected light for direct (i.e. received directly from a nearby distancing device or other light source) or indirect (i.e. received after reflection off an target from a nearby distancing device or other light source) interference.

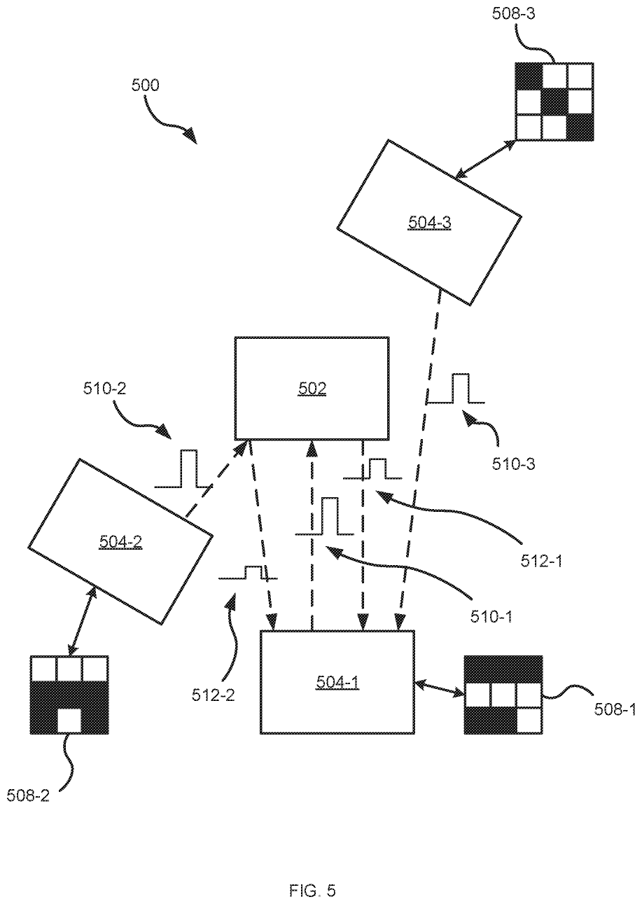

For example, referring to FIG. 5, an example distancing system 500 is depicted. The distancing system 500 includes distancing devices 504-1, 504-2, and 504-3 for distancing a target 502. The distancing devices 504-1, 504-2, and 504-3 have, respectively, device-identifying spatial patterns 508-1, 508-2, and 508-3.

The device 504-1 emits a spatially patterned light pulse 510-1, which is reflected from the target 502 and detected at the device 504-1 as a detected pulse 512-1. The device 504-2 emits a spatially patterned light pulse 510-2, which is reflected from the target 502 and detected at the device 504-1 as an indirectly interfering pulse 512-2. The device 504-3 emits a spatially patterned light pulse 510-3, which is detected at the device 504-1 as a directly interfering pulse.

The device 504-1 may thus extract the relevant detected pulse 512-1 based on the device-identifying spatial pattern 508-1. In particular, the pulse 512-2 and the pulse 510-3 are invalidated by the pattern validator 228 based on the device-identifying spatial pattern 508-1. Accordingly, the pulses 512-2 and 510-3 will not be used for distancing operations at the device 504-1. Accordingly, the device 504-1 produces accurate distance measurements of the target 502 relative to the device 504-1 based on the relevant detected pulse 512-1.

As will be appreciated by persons of skill in the art, various modifications and changes can be made without departing from the scope of the invention as set forth in the claims below. For example, the system 500 may further include a central control device (e.g. a server, laptop, or the like) to assign unique device-identifying spatial patterns 508 to each device 504.

In another example, the device may emit a broad area spatial pattern including a sub-pattern repeated multiple times within the emitted light pulse. That is, the device may illuminate a broad area simultaneously with each pulse. In particular, the device may have a sufficient resolution to allow the sub-pattern to be repeated across the scene. The sub-pattern, in turn, may include the device-identifying spatial pattern. Accordingly, the method 400 may include comparing the detected incoming spatial pattern with the device-identifying spatial pattern. In particular, the device may determine a similarity score of the detected incoming spatial pattern with the sub-pattern including the device-identifying spatial pattern. When the similarity score of the detected incoming spatial pattern to the sub-pattern exceeds a threshold similarity score, the detected incoming spatial pattern may be used to determine the distance of the target.

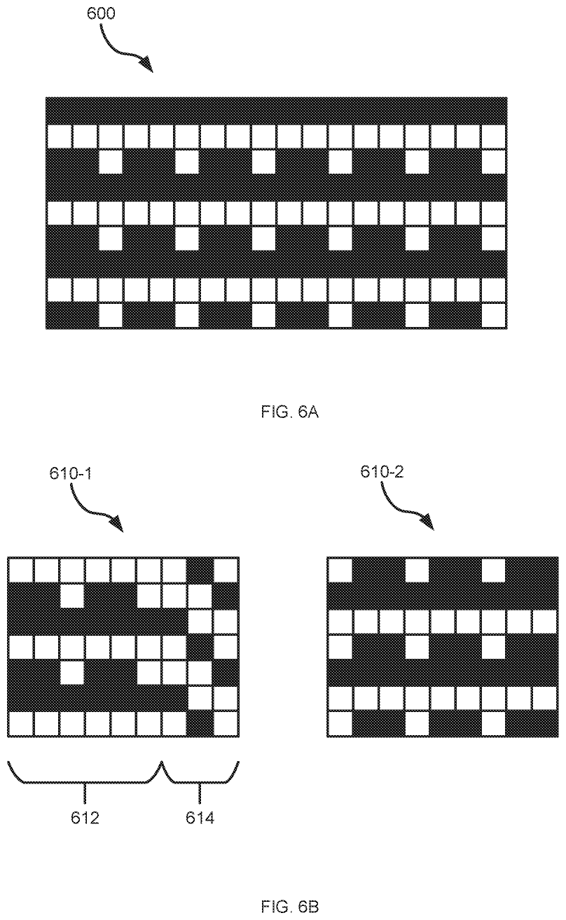

For example, referring to FIGS. 6A and 6B, the operation of broad area illumination for depth mapping (i.e. determining distances of targets) of a scene will be described. The device 104 emits an example broad area spatial pattern 600 including multiple sub-patterns including the device-identifying spatial pattern 508-1. The device 104 further detects a first incoming spatial pattern 610-1 and a second incoming spatial pattern 610-2. For example, the first incoming spatial pattern 610-1 may be reflected, at least partially, off a first object, while the second incoming spatial pattern 610-2 is reflected, at least partially, off a second object. Accordingly, the first and second incoming spatial patterns 610-1 and 610-2 may be detected by the detector 216 at different times. In particular, at block 410 of the method 400, the device 104 may differentiate between the first and second incoming spatial patterns based on a time at which the incoming spatial patterns are received at the detector 216.

The device 104 may proceed to process each incoming spatial pattern 610 individually (i.e. based on the incoming time at which light signals are received at the detector 216). In particular, the pattern validator 228 may apply pattern recognition algorithms to the incoming spatial pattern 610-1 and accept a first portion 612 of the incoming spatial pattern 610-1, which corresponds to the device-identifying spatial pattern 508-1. That is, the pattern validator 228 may determine a similarity score of a portion (or portions) of the incoming spatial pattern with the device-identifying spatial pattern. When the similarity score exceeds a threshold similarity score, the pattern validator 228 determines that the portion is valid. The pattern validator 228 may discard a second portion 614 of the incoming spatial pattern 610-1, which does not correspond with the device-identifying spatial pattern 508-1. That is, the pattern validator 228 may discard the portions of the incoming spatial pattern whose similarity scores do not exceed the threshold similarity score for the device-identifying spatial pattern.

The device 104 may integrate accepted data from each of the incoming spatial patterns 610 (i.e. arriving at different times) to obtain correct arrival times for different objects or portions of the broadly illuminated area. Further, to obtain a complete map without missing pixels, a second pulse with the inverse pattern of the broad area spatial pattern 600 may be emitted. The accepted data from the first pulse and the second pulse are integrated to complete the depth mapping of the scene.

The scope of the claims should not be limited by the embodiments set forth in the above examples, but should be given the broadest interpretation consistent with the description as a whole.

1. A device to determine a distance of a target, the device comprising:
an emitter to emit light pulses according to a device-identifying spatial pattern;
a detector to detect light forming an incoming spatial pattern; and
a processor interconnected with the emitter and the detector, the processor configured to:
determine whether the incoming spatial pattern is valid based on the device-identifying spatial pattern; and
when the incoming spatial pattern is valid, determine the distance of the target based on the incoming spatial pattern.

2. The device of claim 1, wherein the emitter comprises:
a laser to emit laser pulses; and
a spatial light modulator coupled to the laser to receive the laser pulses and spatially modulate the laser pulses according to the device-identifying spatial pattern.

3. The device of claim 1, wherein the processor is further configured to:
determine a similarity score representing a similarity of the incoming spatial pattern and the device-identifying spatial pattern; and
when the similarity score exceeds a threshold similarity score, determine that the incoming spatial pattern is valid.

4. The device of claim 3, wherein the processor is configured to determine the similarity score by determining a percentage of the incoming spatial pattern which corresponds to the device-identifying spatial pattern; and wherein the threshold similarity score is a threshold percentage.

5. The device of claim 3, wherein the processor is further configured to discard the incoming spatial pattern when the similarity score does not exceed the threshold similarity score.

6. The device of claim 1, wherein the detector comprises an array of detector cells, wherein the detector cells are configured to detect light independently.

7. The device of claim 6, wherein, for each detector cell, light detected by the detector cell within a predetermined interval of time forms a portion of the incoming spatial pattern.

8. The device of claim 1, wherein the device-identifying spatial pattern is substantially perpendicular to a direction of emission of the light pulses.

9. A method, in a distancing device, of determining a distance of a target, the method comprising:
emitting light pulses according to a device-identifying spatial pattern;
detecting light forming an incoming spatial pattern;
determining whether the incoming spatial pattern is valid based on the device-identifying spatial pattern; and
when the incoming spatial pattern is valid, determining the distance of the target based on the incoming spatial pattern.

10. The method of claim 9, wherein emitting the light pulses according to the device-identifying spatial pattern comprises:
emitting, from a laser, laser pulses;
receiving the laser pulses at a spatial light modulator; and
spatially modulating the laser pulses according to the device-identifying spatial pattern.

11. The method of claim 9, further comprising:
determining a similarity score representing a similarity of the incoming spatial pattern and the device-identifying spatial pattern; and
when the similarity score exceeds a threshold similarity score, determining that the incoming spatial pattern is valid.

12. The method of claim 11, wherein determining the similarity score comprises:
determining a percentage of the incoming spatial pattern which corresponds to the device-identifying spatial pattern.

13. The method of claim 11, further comprising discarding the incoming spatial pattern when the similarity score does not exceed the threshold similarity score.

14. The method of claim 9, further comprising, after determining the distance of the target, performing a scanning movement to a new position for determining a new distance of a new target.

15. The method of claim 9 wherein the method further comprises:
emitting light pulses according to a broad area spatial pattern, wherein the broad area spatial pattern includes a repeating sub-pattern including the device-identifying spatial pattern.

16. The method of claim 15, wherein determining whether the incoming spatial pattern is valid comprises:
determining a similarity score of a portion the incoming spatial pattern with the device-identifying spatial pattern; and
when the similarity score exceeds a threshold similarity score, determining that the portion of the incoming spatial pattern is valid.

17. The method of claim 9, wherein the device-identifying spatial pattern is substantially perpendicular to a direction of emission of the light pulses.
